(19) United States
(12) Patent Application Publication
(10) Pub. No.: US 2026/0167262 A1
(43) Pub. Date: Jun. 18, 2026

(54) SHAFT RETENTION SCREW FOR COMMERCIAL VEHICLES

(71) Applicant: ZF Active Safety and Electronics US LLC, Livonia, MI (US)

(72) Inventors: Jason Kintner, West Lafayette, IN (US); Kullin Erickson, Lafayette, IN (US); Mari Clendenning, Lafayette, IN (US)

(21) Appl. No.: 18/985,074

(22) Filed: Dec. 18, 2024

(51) Int. Cl. B62D 5/10; B62D 5/18

(52) U.S. Cl. CPC B62D 5/10; B62D 5/18

(57) ABSTRACT

A steering assist system for a commercial vehicle includes an input shaft, an output shaft, an output shaft adapter, a support plate, a worm wheel, and a shaft retention screw. The input shaft defines an input axis and a first hollow portion. The output shaft defines an output axis and a second hollow portion, where the output shaft is disposed within the first hollow portion coaxially to the input shaft. The output shaft adapter defines a third hollow portion that extends through the output shaft adapter axially. The shaft retention screw has a body portion defining external threads, where the shaft retention screw is disposed in the third hollow portion. The body portion extends into the second hollow portion such that the external threads engage with internal threads of the second hollow portion so as to prevent axial separation between the output shaft and the output shaft adapter.

### FIELD

The present disclosure relates to a shaft retention screw for a steering assist system for commercial vehicles.

### BACKGROUND

Steering assemblies of commercial vehicles are susceptible to large amounts of vibration during normal operation and may require larger amounts of force exerted by the driver via the steering wheel on uneven surfaces or in windy conditions. As a commercial vehicle travels on the road, the wheel assemblies of the commercial vehicle may create vibrations or exert torque that is transmitted from the wheels of the vehicle to the steering wheel via the output shaft, steering column, input shaft and the steering wheel assembly. Conventional commercial vehicles may also have heavy torque overlay systems installed on the steering columns that amplify any vibrations generated in the steering column. The vibrations of the steering column and the additional torque inherent when steering a commercial vehicle are undesirable and may lead to decreased steering performance of the commercial vehicle.

### SUMMARY

Embodiments of the present disclosure provide, in a first aspect, a steering assist system for a commercial vehicle, the steering assist system comprising: an input shaft defining an input axis and a first hollow portion, the input shaft configured to engage with a steering column of the commercial vehicle; an output shaft defining an output axis and a second hollow portion, the output shaft being disposed within the first hollow portion coaxially to the input shaft, the second hollow portion defining internal threads; an output shaft adapter defining a third hollow portion extending through the output shaft adapter axially, the third hollow portion having a smaller diameter region at a first end and a larger diameter region adjacent to the smaller diameter region, a shoulder being defined at a transition between the smaller diameter region and the larger diameter region, wherein the output shaft adapter is disposed at the first end of the output shaft such that the smaller diameter region circumferentially surrounds the output shaft; a support plate including a bearing configured to receive the output shaft adapter and guide rotation of the output shaft adapter; a worm wheel circumferentially surrounding the output shaft adapter, the worm wheel having an outer circumference configured to engage a worm shaft for steering assist; and a shaft retention screw having a head portion defining a flange and a body portion defining external threads, the shaft retention screw being disposed in the third hollow portion such that the flange engages with the shoulder and the body portion extends into the second hollow portion such that the external threads engage with the internal threads of the output shaft so as to prevent axial separation between the output shaft and the output shaft adapter.

According to an implementation of the first aspect, the steering assist system may further comprise a sensor arrangement circumferentially surrounding the input shaft and the output shaft, wherein the sensor arrangement is configured to measure an angular difference between the input shaft and the output shaft.

According to an implementation of the first aspect, the output shaft adapter may further comprise splines for engaging with a shaft of a hydraulic steering gear assembly of the commercial vehicle.

According to an implementation of the first aspect, the steering assist system may further comprise a torsion bar disposed coaxially within the first and second hollow portions.

According to an implementation of the first aspect, the shaft retention screw may further include an internal hex drive screw for rotating the shaft retention screw such that the external threads engage with the internal threads.

According to an implementation of the first aspect, the flange may have a diameter that is larger than the smaller diameter region.

According to an implementation of the first aspect, the steering assist system may further comprise a housing configured to receive the support plate, the housing and the support plate configured to prevent movement of the input shaft, the output shaft, and the output shaft adapter in a radial direction.

According to an implementation of the first aspect, the output shaft may be press fit into the output shaft adapter.

According to an implementation of the first aspect, the output shaft adapter may be configured to engage with a hydraulic steering gear input shaft of the commercial vehicle.

### BRIEF DESCRIPTION OF THE DRAWINGS

Embodiments of the present disclosure will be described in greater detail below based on the exemplary figures. The present disclosure is not limited to the exemplary embodiments. All features described and/or illustrated herein can be used alone or combined in different combinations in embodiments of the present disclosure. The features and advantages of various embodiments of the present disclosure will become apparent by reading the following detailed description with reference to the attached drawings which illustrate the following:

FIG. 1 illustrates a side cross-section view of a steering assist system with a shaft retention screw, according to one or more examples of the present disclosure;

FIG. 2 illustrates a perspective view of steering assist system with a cover mount and main housing of a ReAX module with Electronic Power Pack attached, according to one or more examples of the present disclosure;

FIG. 3 illustrates a perspective view of a steering assist system including an input-output assembly, sensor sub-assembly, worm wheel, output shaft adapter, and shaft retention screw, according to one or more examples of the present disclosure;

FIG. 4 illustrates a perspective view of a ReAX module assembled with the steering assist system, and a hydraulic steering gear assembly, according to one or more examples of the present disclosure; and

FIG. 5 illustrates a perspective view of a ReAX-Gear system assembly.

### DETAILED DESCRIPTION

Examples of the presented application will now be described more fully hereinafter with reference to the accompanying FIGs., in which some, but not all, examples of the application are shown. Indeed, the application may be exemplified in different forms and should not be construed as limited to the examples set forth herein; rather, these examples are provided so that the application will satisfy applicable legal requirements. Where possible, any terms expressed in the singular form herein are meant to also include the plural form and vice versa, unless explicitly stated otherwise. Also, as used herein, the term “a” and/or “an” shall mean “one or more” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on”.

Steering assemblies of commercial vehicles are susceptible to large amounts of vibration during normal operation and may require larger amounts of force exerted by the driver via the steering wheel on uneven surfaces, at low vehicle speeds, or in windy conditions. As commercial vehicle travels on the road, the wheel assemblies of the commercial vehicle may create vibrations or exert torque that is transmitted from the wheels of the RV to the steering wheel via the output shaft, steering column, input shaft and the steering wheel assembly. Conventional commercial vehicles may also have heavy torque overlay systems installed on the steering columns that amplify any vibrations generated in the steering column. The vibrations of the steering column and the additional torque inherent when steering a commercial vehicle are undesirable and may lead to decreased steering performance of the commercial vehicle.

The present disclosure describes using a shaft retention screw to support existing input-output assemblies of steering columns or steering assist systems to prevent undesired relative axial movement between an output shaft and output shaft adapter in existing steering assist systems or steering columns. By installing a shaft retention screw to the existing input-output assemblies of steering columns or steering assist systems, the existing steering columns or steering assist systems may be made more durable and provide superior performance and reliability in the operations of a commercial vehicle. An advantage of the shaft retention screw of the present disclosure is that the shaft retention screw can be implemented into the existing design of the steering system of a commercial vehicle thereby bypassing the need to redesign the steering system.

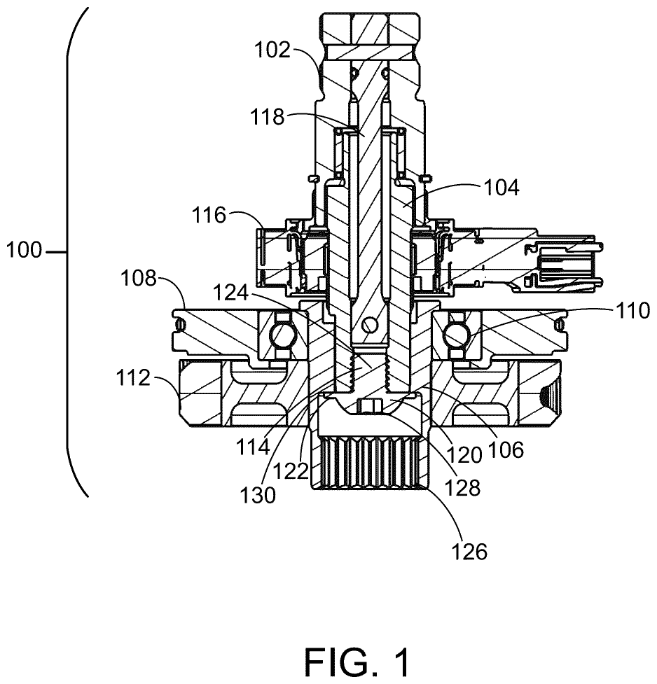

FIG. 1 illustrates a side cross-section view of a steering assist system with a shaft retention screw, according to one or more examples of the present disclosure. FIG. 1 depicts a side cross-section view of the steering assist system 100. The steering assist system 100 includes an input shaft 102, an output shaft 104, an output shaft adapter 106, a support plate 108 including a bearing 110, a worm wheel 112, a shaft retention screw 114, a sensor(s), sensor assembly, or sensor arrangement 116, and a torsion bar 118. In embodiments, the input shaft may define an input axis and a first hollow portion. The input shaft 102 may be configured to engage with a steering column of a commercial vehicle. In embodiments, the output shaft 104 defines an output axis and a second hollow portion. The output shaft 104 is disposed within the first hollow portion coaxially to the input shaft 102. In embodiments, the second hollow portion of the output shaft 104 defines internal threads. In embodiments, the output shaft adapter 106 defines a third hollow portion extending through the output shaft adapter axially. The third hollow portion may have a smaller diameter region at a first end and a larger diameter region adjacent to the smaller diameter region, where a shoulder 130 is defined at a transition between the smaller diameter region and the larger diameter region.

In embodiments, the output shaft adapter 106 is disposed at the first end of the output shaft 104 such that the smaller diameter region circumferentially surrounds the output shaft 104. In embodiments, the support plate 108 includes the bearing 110, where the bearing 110 is configured to receive the output shaft adapter 106 and guide rotation of the output shaft adapter 106. In embodiments, the worm wheel 112 circumferentially surrounds the output shaft adapter 106 and is configured to engage a worm shaft for steering assist of a commercial vehicle. In embodiments, the shaft retention screw 114 has a head portion 120 defining a flange 122 and a body portion 124 defining external threads. The shaft retention screw 114 is disposed in the third hollow portion of the output shaft adapter 106 such that the flange 122 is in contact with the shoulder 130 and the body portion 124 extends into the second hollow portion of the output shaft 104 such that the external threads of the body portion 124 engage with the internal threads of the output shaft 104 so as to prevent axial separation between the output shaft 104 and the output shaft adapter 106.

In embodiments, the output shaft adapter includes splines 126 for engaging with a hydraulic steering gear of a commercial vehicle. In embodiments, the output shaft adapter 106 is configured to engage with a hydraulic steering gear input shaft of a commercial vehicle. In embodiments, the torsion bar 118 is disposed coaxially within the first and second hollow portions of the input shaft 102 and the output shaft 104, respectively. In embodiments, the sensor or sensor assembly 116 circumferentially surrounds the input shaft 102 and the output shaft 104. The sensor or sensor assembly 116 is configured to measure an angular difference between the input shaft 102 and the output shaft 104. The readings or measurements obtained by the sensor or sensor assembly 116 are electronically communicated or transmitted to an electronic control unit (ECU) of the steering assist system to generate torque assistance to aid a driver during operation of the commercial vehicle.

In embodiments, the shaft retention screw 114 includes an internal hex drive screw 128 that is used torque or rotate the shaft retention screw 114 such that the external threads of the body portion 124 engage with the internal threads of the output shaft 104. In some embodiments, the flange 122 has a diameter that corresponds to the larger diameter region of the output shaft adapter 106 (e.g, the flange 122 has a diameter that is larger than the smaller diameter region). In embodiments, the output shaft 104 and the output shaft adapter 106 are press fit together to form a first engagement force between the output shaft 104 and the output shaft adapter 106. For example, the output shaft 104 has an outer diameter that is larger than an inner diameter of the output shaft adapter 106. A force is applied to press fit the output shaft 104 into the output shaft adapter 106 where the output shaft 104 compresses slightly while the output shaft adapter 106 expands slightly to allow the fit between the two objects 104 and 106. The press fitting of the output shaft 104 and the output shaft adapter 106 results in a force being applied to each other to hold the output shaft 104 and the output shaft adapter 106 together. A second engagement force between the output shaft 104 and the output shaft adapter 106 results from the shaft retention screw 114 as the external threads of the body portion 124 of the shaft retention screw 114 engage with the internal threads of the output shaft 104.

In embodiments, the input shaft 102, output shaft 104, torsion bar 118, and output shaft adapter 106, as well as the other components depicted in FIG. 1 (108-128), work together to make steering easier by adding power assistance to a driver's steering effort for the commercial vehicle. For example, the input shaft 102 is connected to a steering column and steering wheel of a commercial vehicle. As a driver turns the steering wheel, the input shaft 102 rotates thereby transmitting the driver's steering effort into the steering assist system 100. The torsion bar 118, in some embodiments, connects the input shaft 102 to the output shaft 104. The torsion bar 118 twists proportionally to an amount of force applied by the driver on the steering wheel. The amount of twist is measured, by sensor or sensor assembly 116, to determine or compute how much assistance is needed by the driver. An associated computer, ECU, of the steering assist system 100, receives the measurements obtained by the sensor or sensor assembly 116 as well as data from other sensors of the steering assist system 100, and provides it to an algorithm for determining actuation instructions for an associated electronic motor to provide steering assistance or lane keeping assistance. In embodiments, the output shaft 104 connects, ultimately, to the wheels of a commercial vehicle. The output shaft 104 receives a combined force of the driver's input and the assist force generated by the steering assist system 100 then directs this motion to the wheels for turning so as to provide steering assistance or lane keeping assistance.

In embodiments, the output shaft adapter 106 links or otherwise connects the output shaft 104 to the worm wheel 112. The output shaft adapter 106 transmits the assisted torque generated by the steering assist system 100 smoothly from the worm wheel 112 to the output shaft 104. In embodiments, the worm wheel 112 engages or otherwise works with a worm gear to provide the assist force that aids a driver. When steering assistance is required by a driver, an electronic motor turns the worm gear which engages with the worm wheel and generates additional torque to assist in turning the wheels of the commercial vehicle. In embodiments, the sensor or sensor assembly 116 detects various metrics such as the position and force on the input shaft 102, the angle of the connected steering wheel, and a twist of the torsion bar 118. These metrics can be used by the ECU and implemented algorithms of the ECU to determine how much steering assistance is needed and to adjust the assist force as necessary. In embodiments, the bearing 110 supports movement of the input shaft 102 and output shaft 104 reducing friction and wear while allowing for smooth rotation of the input shaft 102 and output shaft 104 as they work together during operation of the commercial vehicle. In embodiments, the support plate 108 secures the worm wheel 112 and bearing 110 and provides structural support to other components such as the output shaft adapter 106, output shaft 104, and input shaft 102. The output shaft adapter 106 may be in-directly connected to the steering wheel of a commercial vehicle which means that the torque from the electric motor is indirectly augmenting the feeling that the driver feels in the steering wheel. As a driver operates the commercial vehicle and the steering assist system 100 provides assistance the output shaft 104 and the output shaft adapter 106 receives forces which attempt to separate them in an axial direction. The press fit of the output shaft 104 and the output shaft adapter 106 as well as the shaft retention screw 114 secure these components together and prevent separation in an axial direction.

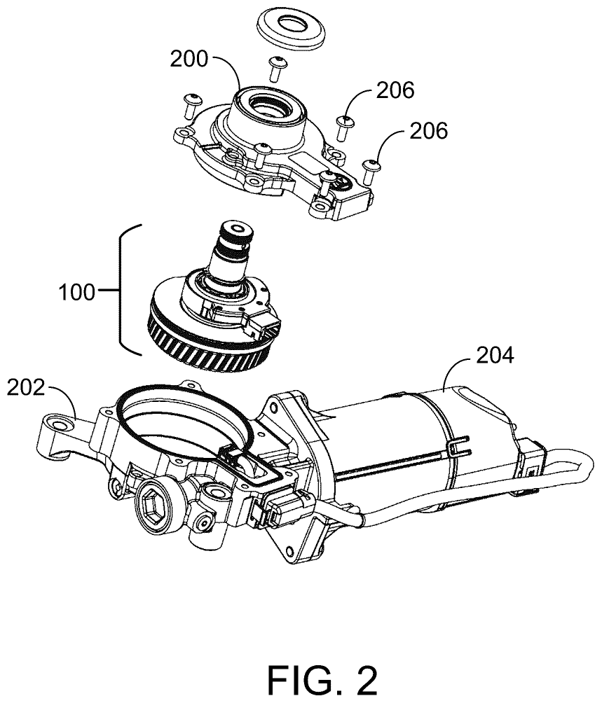

FIG. 2 illustrates a perspective view of steering assist system 100 with a cover mount 200 and main housing 202 of a ReAX module with Electronic Power Pack 204 attached, according to one or more examples of the present disclosure. In embodiments, the steering assist system 100 mounts into the main housing 202 and the cover mount 200 secures the steering assist system 100 to the main housing 202 via bolts 206. In embodiments, the main housing 202 is configured to receive the support plate of the steering assist system 100 and together these components prevent movement of the input shaft, output shaft, and output shaft adapter in a radial direction. In embodiments, the Electronic Power Pack 204 delivers power to the electric motor of the steering assist system of a commercial vehicle. The electric motor generates the necessary torque to assist in steering thereby reducing the physical effort required by the driver to steer or to aid in lane keeping assistance.

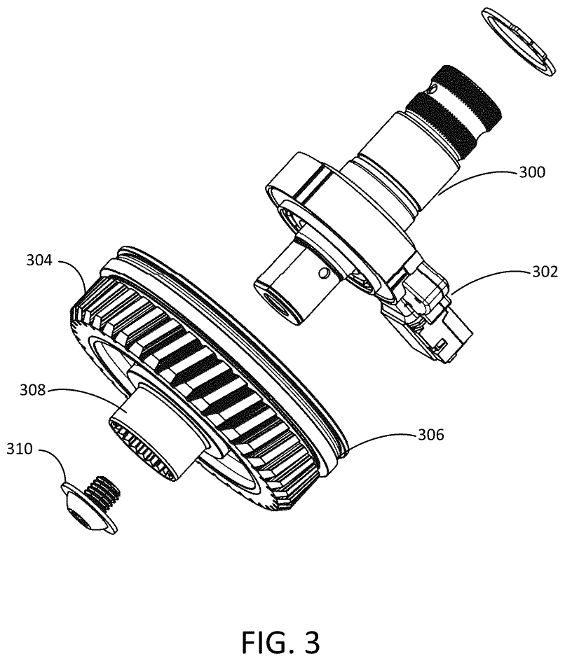

FIG. 3 illustrates a perspective view of a steering assist system including an input-output assembly 300, sensor sub-assembly 302, worm wheel 304, support plate 306, output shaft adapter 308, and shaft retention screw 310, according to one or more examples of the present disclosure. As depicted in FIG. 3, the worm wheel 304 and output shaft adapter 308 are mounted to support plate 306. The input-output assembly 300, which may include the input shaft, the output shaft, and a torsion bar disposed coaxially within the input shaft, output shaft, and output shaft adapter 308 upon being assembled as depicted in FIG. 1. As described herein, the sensor sub-assembly (sensor arrangement) 302 circumferentially surrounds the input-output assembly 300 (e.g., the input shaft, output shaft, and torsion bar). In embodiments, the shaft retention screw 310 includes threads (e.g. external threads) which engage, upon being acted upon by a torquing force, into threads (e.g. internal threads) of the output shaft of the input-output shaft assembly 300 thereby securing the output shaft adapter 308 and the input-output assembly 300. The output shaft adapter 308 and the input-output assembly 300 are also press fit together and the shaft retention screw 310 provides an additional secure force to these components that prevents separation in an axial direction.

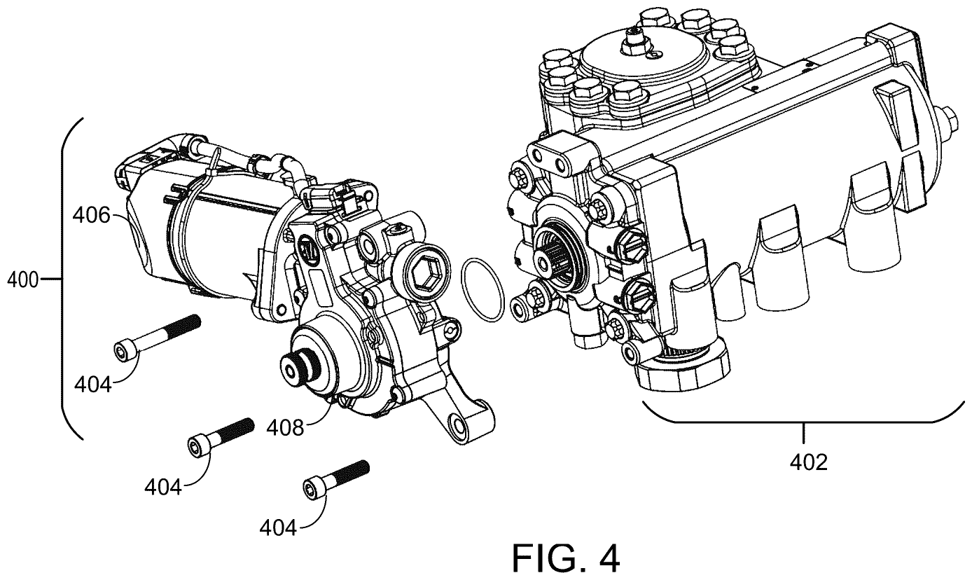

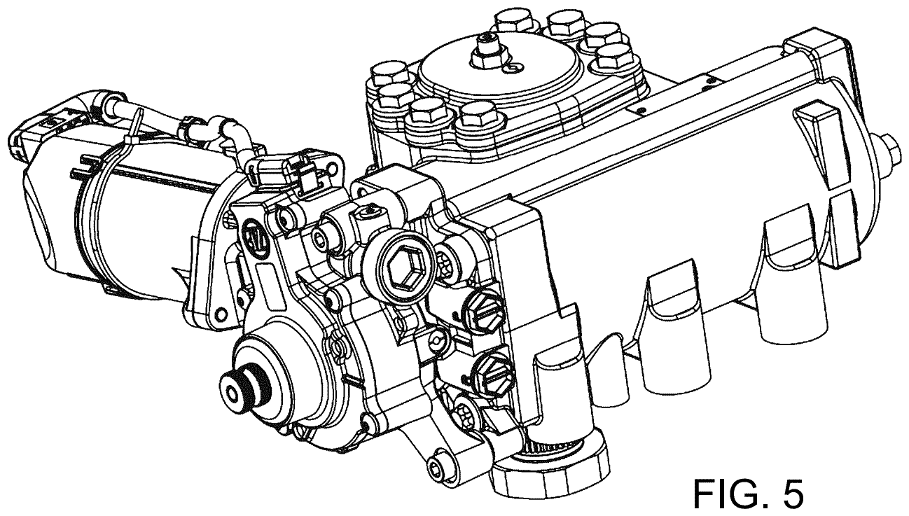

FIG. 4 illustrates a perspective view of a ReAX module 400 assembled with the steering assist system, and a hydraulic steering gear assembly 402 assembled, according to one or more examples of the present disclosure. In embodiments, the ReAX module 400 assembly is mounted to the hydraulic steering gear assembly 402 via mounting bolts 404. The ReAX module 400 includes the electronic power pack 406 and the input-output assembly 408 that includes the components as described above with reference to FIGS. 1 and 2. The ReAX module 400 and the hydraulic steering gear assembly 402 once assembled together form the ReAX-Gear system of the steering assistance system. A perspective view of the ReAX-Gear system assembly is depicted in FIG. 5. In embodiments, the hydraulic steering gear assembly 402 uses hydraulic fluid pressure to aid the ReAX module 400 in providing steering assistance and lane keeping assistance to the commercial vehicle.

While subject matter of the present disclosure has been illustrated and described in detail in the drawings and foregoing description, such illustration and description are to be considered illustrative or exemplary and not restrictive. Any statement made herein characterizing the present disclosure is also to be considered illustrative or exemplary and not restrictive as the present disclosure is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A steering assist system for a commercial vehicle, the steering assist system comprising:
an input shaft defining an input axis and a first hollow portion, the input shaft configured to engage with a steering column of the commercial vehicle;
an output shaft defining an output axis and a second hollow portion, the output shaft being disposed within the first hollow portion coaxially to the input shaft, the second hollow portion defining internal threads;
an output shaft adapter defining a third hollow portion extending through the output shaft adapter axially, the third hollow portion having a smaller diameter region at a first end and a larger diameter region adjacent to the smaller diameter region, a shoulder being defined at a transition between the smaller diameter region and the larger diameter region,
wherein the output shaft adapter is disposed at the first end of the output shaft such that the smaller diameter region circumferentially surrounds the output shaft;
a support plate including a bearing configured to receive the output shaft adapter and guide rotation of the output shaft adapter;
a worm wheel circumferentially surrounding the output shaft adapter, the worm wheel having an outer circumference configured to engage a worm shaft for steering assist; and
a shaft retention screw having a head portion defining a flange and a body portion defining external threads, the shaft retention screw being disposed in the third hollow portion such that the flange engages with the shoulder and the body portion extends into the second hollow portion such that the external threads engage with the internal threads of the output shaft so as to prevent axial separation between the output shaft and the output shaft adapter.

2. The steering assist system of claim 1, further comprising a sensor arrangement circumferentially surrounding the input shaft and the output shaft, wherein the sensor arrangement is configured to measure an angular difference between the input shaft and the output shaft.

3. The steering assist system of claim 1, wherein the output shaft adapter further comprises splines for engaging with a shaft of a hydraulic steering gear assembly of the commercial vehicle.

4. The steering assist system of claim 1, further comprising a torsion bar disposed coaxially within the first and second hollow portions.

5. The steering assist system of claim 1, wherein the shaft retention screw further includes an internal hex drive screw for rotating the shaft retention screw such that the external threads engage with the internal threads.

6. The steering assist system of claim 1, wherein the flange has a diameter that is larger than the smaller diameter region.

7. The steering assist system of claim 1, further comprising a housing configured to receive the support plate, the housing and the support plate configured to prevent movement of the input shaft, the output shaft, and the output shaft adapter in a radial direction.

8. The steering assist system of claim 1, wherein the output shaft is press fit into the output shaft adapter.

9. The steering assist system of claim 1, wherein the output shaft adapter is configured to engage with a hydraulic steering gear input shaft of the commercial vehicle.
